(19) United States
(12) Patent Application Publication
(10) Pub. No.: US 2018/0122351 A1
(43) Pub. Date: May 3, 2018

(54) TRANSDUCER MOUNTING DEVICE

(71) Applicant: Garmin Switzerland GmbH, Schaffhausen (CH)

(72) Inventor: Troy D. Simonton, Paola, KS (US)

(21) Appl. No.: 15/794,875

(22) Filed: Oct. 26, 2017

Related U.S. Application Data
(60) Provisional application No. 62/415,263, filed on Oct. 31, 2016.

(51) Int. Cl. G10K 11/00; F16M 13/02

(52) U.S. Cl. CPC G10K 11/006; B63B 9/00; B63B 2221/10; F16M 13/02

(57) ABSTRACT

A transducer mounting device includes a deformable substrate having a first side and a second side. The deformable substrate defines an aperture having an inner diameter and an outer diameter configured to receive a transducer assembly so that at least a portion of the transducer assembly is disposed in the aperture between the first side and the second side. The deformable substrate has an adhesive layer disposed upon the second side of the deformable substrate. The adhesive layer is configured to adhere the deformable substrate to a surface.

### CROSS-REFERENCE TO RELATED APPLICATIONS

The present application claims the benefit under 35 U.S.C. § 119(e) of U.S. Provisional Application Ser. No. 62/415,263, filed Oct. 31, 2016, and titled “TRANDSUCER MOUNTING RING,” which is herein incorporated by reference in its entirety.

### BACKGROUND

Access to a hull of a marine vessel (e.g., boat) from inside the marine vessel is often limited. For instance, a user may only be able to access an inner surface of the hull through a small opening. The acoustic energy generated (and received) by a transducer element (e.g., ceramic transducer element) within a transducer assembly that is mounted within a marine vessel must pass through the hull. Accordingly, it is advantageous to mount the transducer assembly directly to an inner surface of the hull. However, because access to the hull is often limited, installation of a transducer assembly against the inner surface of the hull is challenging, and the performance of a transducer element may be impacted by poor installation.

### SUMMARY

A device for mounting a transducer assembly within a vessel is disclosed. The device includes a deformable substrate having a first side and a second side. The deformable substrate defines an aperture configured to receive a transducer assembly so that at least a portion of the transducer assembly is disposed between the first side and the second side. The deformable substrate has an adhesive layer disposed upon the second side of the deformable substrate. The adhesive layer is configured to adhere the deformable substrate to a surface within a vessel.

A system for mounting a transducer assembly within a vessel is also disclosed. The system includes a transducer assembly, a deformable substrate having a first side and a second side, and an epoxy. The deformable substrate defines an aperture configured to receive the transducer assembly so that at least a portion of the transducer assembly is disposed between the first side and the second side. The deformable substrate has an adhesive layer disposed upon the second side of the deformable substrate. The adhesive layer is configured to adhere the deformable substrate to a surface within a vessel. The epoxy is disposed within the aperture. The epoxy is configured to affix the transducer assembly to the surface.

A method for mounting a transducer assembly within a vessel is also disclosed. In an implementation, the method includes: adhering a first side of a deformable substrate to a surface within a vessel; disposing an epoxy within an aperture defined by the deformable substrate; and disposing a transducer assembly within the aperture so that at least a portion of the transducer assembly is disposed between the first side of the deformable substrate and a second side of the deformable substrate.

This Summary is provided solely as an introduction to subject matter that is fully described in the Detailed Description and Drawings. The Summary should not be considered to describe essential features nor be used to determine the scope of the Claims. Moreover, it is to be understood that both the foregoing Summary and the following Detailed Description are example and explanatory only and are not necessarily restrictive of the subject matter claimed.

### BRIEF DESCRIPTION OF THE DRAWINGS

The detailed description is described with reference to the accompanying figures. The use of the same reference numbers in different instances in the description and the figures may indicate similar or identical items. Various embodiments or examples (“examples”) of the present disclosure are disclosed in the following detailed description and the accompanying drawings. The drawings are not necessarily to scale. In general, operations of disclosed processes may be performed in an arbitrary order, unless otherwise provided in the claims.

FIG. 1A is a perspective view of a transducer assembly mounted to a surface with the aid of a transducer mounting device, in accordance with an example embodiment of the present disclosure.

FIG. 1B is a partial cross-sectional side view of a transducer assembly mounted to a surface with the aid of a transducer mounting device, in accordance with an example embodiment of the present disclosure.

FIG. 2A is a perspective view of a transducer mounting device, such as the transducer mounting device of FIG. 1A and/or FIG. 1B, in accordance with an example embodiment of the present disclosure.

FIG. 2B is a top view of a transducer mounting device, such as the transducer mounting device of FIG. 1A and/or FIG. 1B, in accordance with an example embodiment of the present disclosure.

FIG. 2C is a bottom view of a transducer mounting device, such as the transducer mounting device of FIG. 1A and/or FIG. 1B, in accordance with an example embodiment of the present disclosure.

FIG. 2D is a side view of a transducer mounting device, such as the transducer mounting device of FIG. 1A and/or FIG. 1B, in accordance with an example embodiment of the present disclosure.

FIG. 3A is a block diagram of a marine vessel display system, in accordance with an example embodiment of the present disclosure.

FIG. 3B is a block diagram of a marine vessel display system having multiple displays and/or display stations, in accordance with an example embodiment of the present disclosure.

FIG. 4A is a top view of a marine vessel in which a transducer mounting device can be utilized to mount a transducer assembly to a surface within the marine vessel, where the transducer assembly can be communicatively coupled with one or more components of a marine vessel display system for the marine vessel, such as the marine vessel display system of FIG. 3A and/or FIG. 3B, in accordance with an example embodiment of the present disclosure.

FIG. 4B is a perspective view of a display for a marine vessel display system, such as the marine vessel display system of FIG. 3A and/or FIG. 3B, in accordance with an example embodiment of the present disclosure.

FIG. 4C is a partial cross-sectional side view of a marine vessel, such as the marine vessel of FIG. 4C, in which a transducer mounting device can be utilized to mount a transducer assembly to a surface within the marine vessel, where the transducer assembly can be communicatively coupled with one or more components of a marine vessel display system for the marine vessel, such as the marine vessel display system of FIG. 3A and/or FIG. 3B, in accordance with an example embodiment of the present disclosure.

FIG. 5 is a flow diagram illustrating a process for mounting a transducer assembly to a surface utilizing a transducer mounting device, such as the transducer mounting device illustrated in any of FIGS. 1A through 2D, in accordance with an example implementation of the present disclosure.

FIG. 6A is a side view of a surface with a mounting location for mounting a transducer assembly, where the mounting location is prepared by forming abrasions at the mounting location and cleaning the mounting location prior to mounting the transducer assembly, in accordance with an example implementation of the present disclosure.

FIG. 6B is a side view of a transducer mounting device, such as the transducer mounting device illustrated in any of FIGS. 1A through 2D, where a cover layer is at least partially removed to expose an adhesive layer of the transducer mounting device, in accordance with an example implementation of the present disclosure.

FIG. 6C is a side view of a transducer mounting device, such as the transducer mounting device illustrated in any of FIGS. 1A through 2D, where the transducer mounting device is adhered to a mounting location on a surface, in accordance with an example implementation of the present disclosure.

FIG. 6D is a side view of a transducer mounting device, such as the transducer mounting device illustrated in any of FIGS. 1A through 2D, where the transducer mounting device is adhered to a mounting location on a surface, and an epoxy is disposed within an aperture of the transducer mounting device, in accordance with an example implementation of the present disclosure.

FIG. 6E is a side view of a transducer mounting device, such as the transducer mounting device illustrated in any of FIGS. 1A through 2D, where the transducer mounting device is adhered to a mounting location on a surface, and an epoxy is disposed within an aperture of the transducer mounting device, and a transducer assembly is disposed within the aperture of the transducer mounting device so that the epoxy affixes the transducer assembly to the surface, in accordance with an example implementation of the present disclosure.

FIG. 6F is a side view of a transducer assembly affixed to a surface by an epoxy, such as the transducer assembly of FIG. 6E, where the transducer mounting device has been removed, in accordance with an example implementation of the present disclosure.

### DETAILED DESCRIPTION

A transducer assembly may include a housing or enclosure containing with a transducer element (e.g., a sonic and/or ultrasonic transducer) disposed within the housing or enclosure. For example, the transducer element can include, but is not limited to, a ceramic transducer element or the like. In some implementations, a transducer element includes a circular transducer element that outputs a conical sonar (e.g., sonic/ultrasonic) beam. The transducer assembly may be installed in a vessel (e.g., a marine vessel, aircraft, car, truck, train, or the like). For example, in a marine vessel (e.g., a boat), a transducer assembly may be installed at an inner surface of the marine vessel's hull that is flat so the sonar beam is output directly below the marine vessel. Some installation techniques rely upon the use of temporary retaining structures formed using putty (e.g., plumber's putty) that may not always provide the seal or structure needed to tightly secure the transducer assembly to a mounting location on a surface within a vessel (e.g., within the marine vessel (e.g., an inner surface of the hull)).

A device for mounting a transducer assembly within a vessel is disclosed. The device includes a deformable substrate having a first side and a second side. The deformable substrate defines an aperture configured to receive a transducer assembly so that at least a portion of the transducer assembly is disposed between the first side and the second side. The deformable substrate has an adhesive layer (e.g., glue, double sided tape, or the like) disposed upon the second side of the deformable substrate. In some embodiments, the adhesive layer is a waterproof, water resistant, and/or water tight adhesive layer. The adhesive layer is configured to adhere the deformable substrate to a surface within a vessel. An epoxy (e.g., an epoxy resin, putty, glue, sealer, hardener, rubber cement, or the like) may be disposed within the aperture prior to disposing the transducer assembly within the aperture. In some embodiments, the epoxy is a marine epoxy or a marine-grade epoxy. The epoxy, when cured (e.g., by exposure to the atmosphere (e.g., drying), heating, cooling, light curing, or the like), is configured to affix the transducer assembly to the surface (i.e., at a mounting location on the surface) within the vessel.

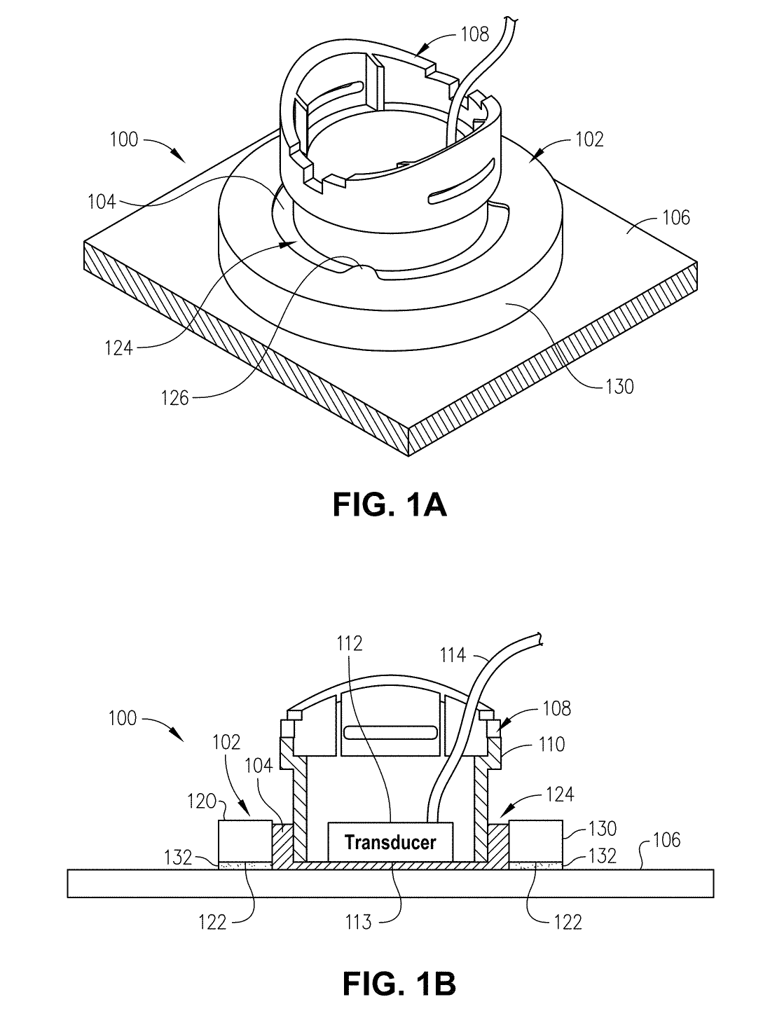

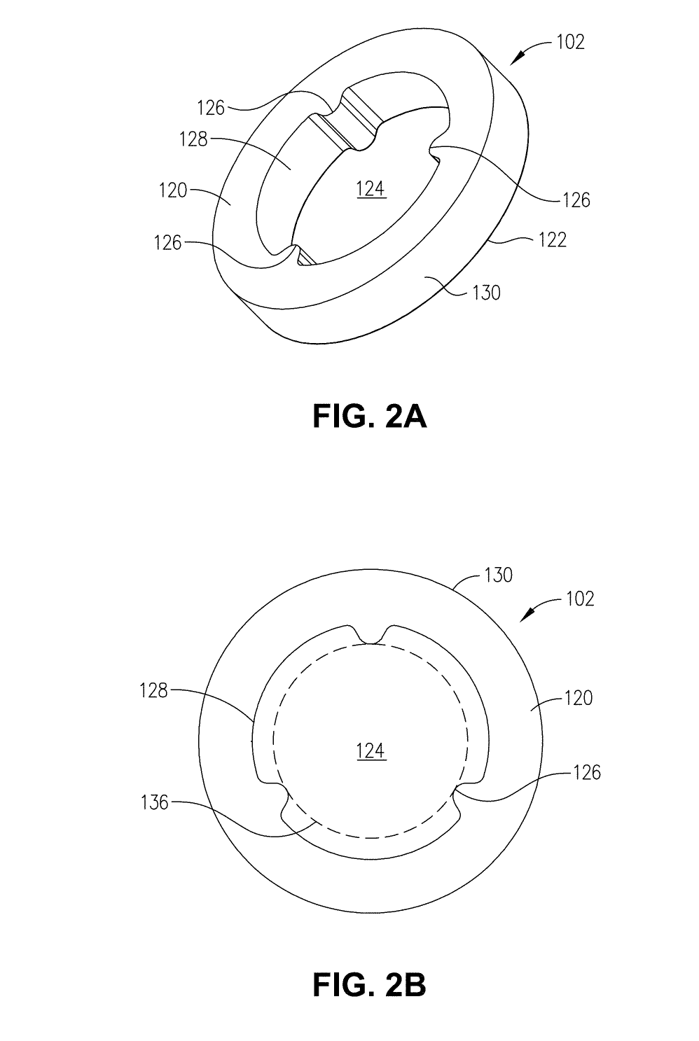

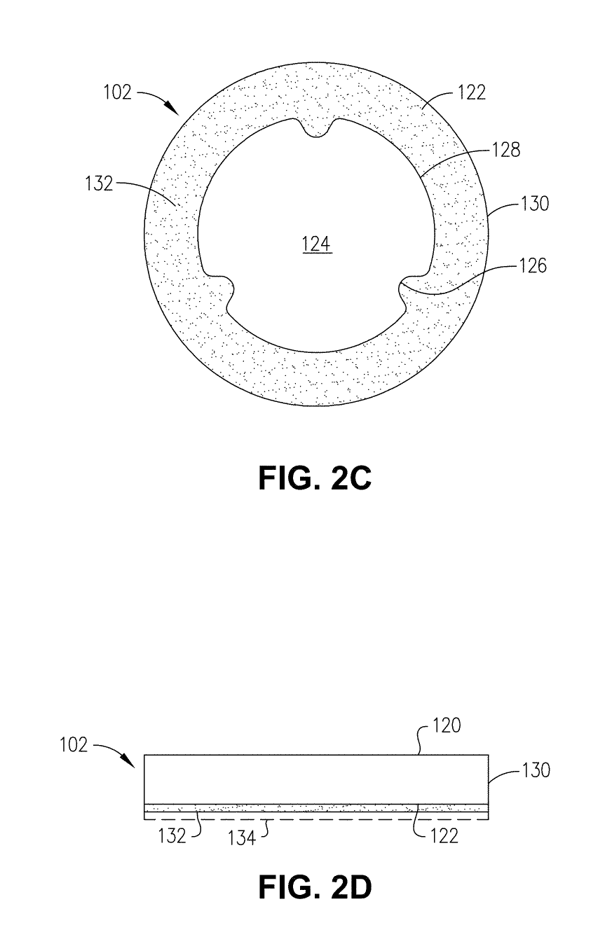

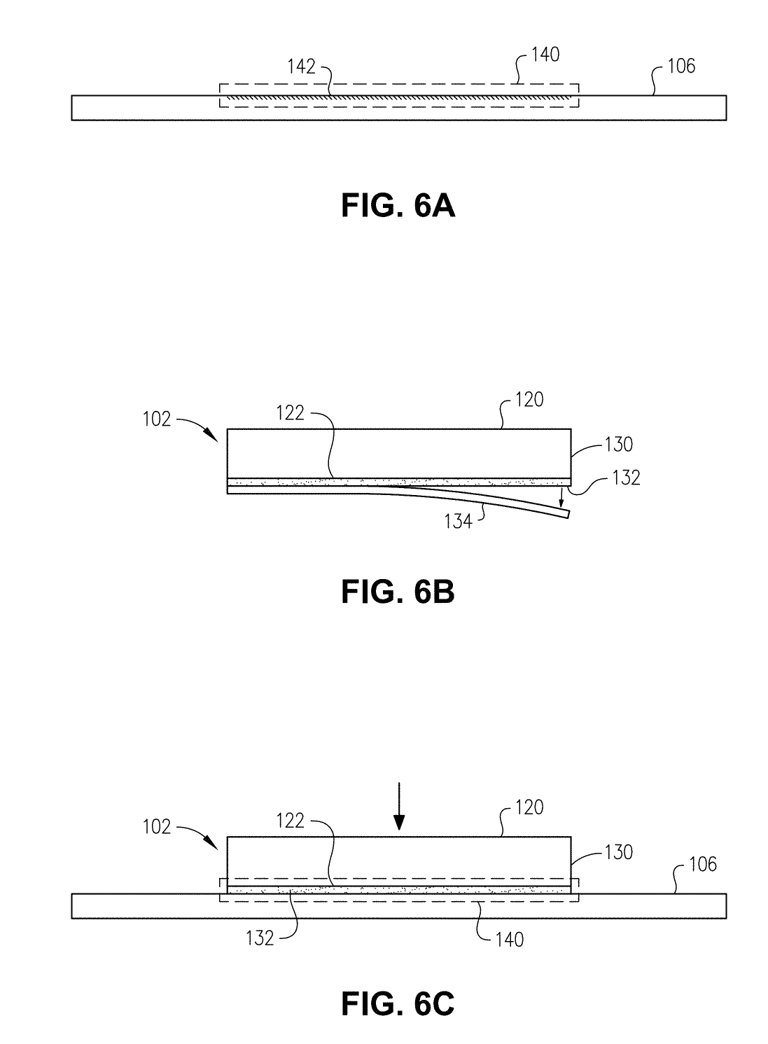

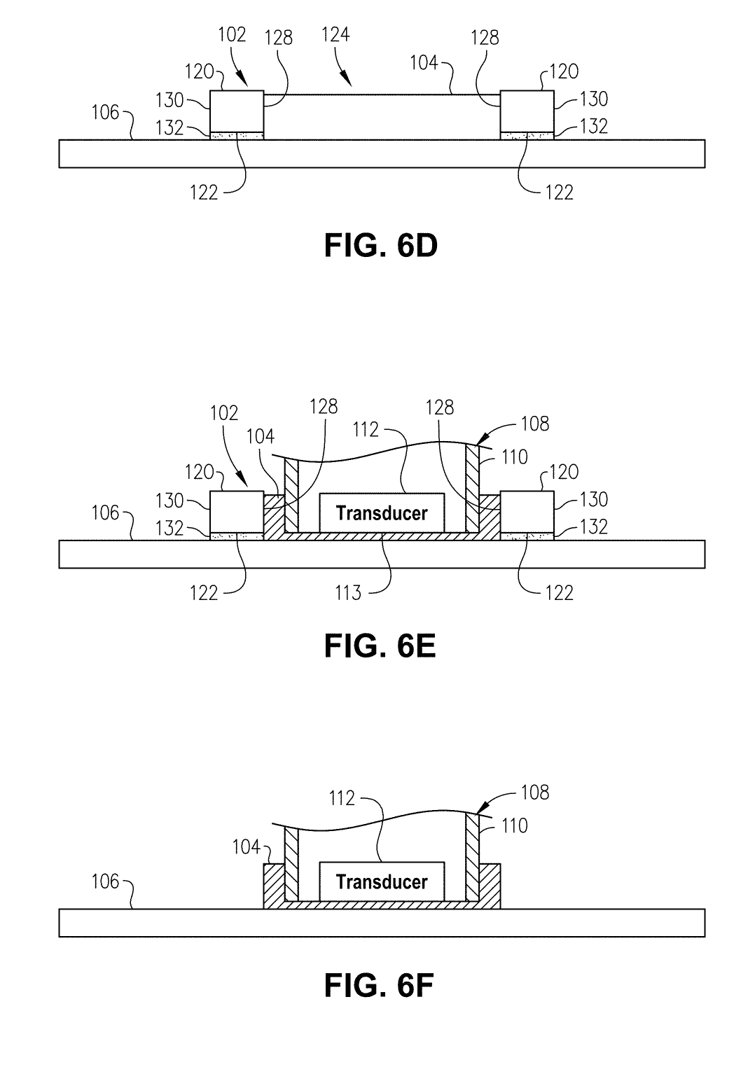

FIGS. 1A through 2D illustrate embodiments of a system 100 that employs a transducer mounting device 102 to mount a transducer assembly 108 to a surface 106. As further described herein, the transducer mounting device 102 is configured to provide structural support for the transducer assembly 108 while the transducer assembly 108 is mounted the surface 106. For example, the transducer mounting device 102 is configured to stabilize or at least partially stabilize the transducer assembly 108 relative to the surface 106. In some embodiments, the transducer mounting device 102 is configured to stabilize the transducer assembly 108 relative to the surface 106 while an epoxy 104 is cured to affix the transducer assembly 108 to the surface 106. For example, FIGS. 1A and 1B show an embodiment of the system 100 where the transducer mounting device 102 is disposed upon (e.g., adhered, or otherwise affixed to) the surface 106, the epoxy 104 is disposed within an aperture 124 of the transducer mounting device 102, and the transducer assembly 108 is also disposed within the aperture 124 of the transducer mounting device 102. In some embodiments, the transducer mounting device 102 is retained as part of the final structure of the installed transducer assembly 108. In other embodiments, the transducer mounting device 102 may be removed after the epoxy 104 has been cured (e.g., as shown in FIG. 6F).

As shown in FIG. 1B, the transducer assembly 108 includes a transducer element 112. In some embodiments, the transducer element 112 is a ceramic transducer element. In some embodiments, the transducer element 112 is a circular transducer element that is configured to emit a conical sonar (e.g., sonic/ultrasonic) beam. The transducer element 112 can include any type of transducer element configured to emit and/or detect a sonar signal for object detection, ranging, motion detection, and/or imaging applications, or the like. In an embodiment, the transducer assembly 108 also includes a housing 110 configured to at least partially surround or contain the transducer element 112. For example, the housing 110 can be a ceramic, plastic, rubber, and/or metal enclosure that at least partially surrounds or contains the transducer element 112. In some embodiments, the transducer assembly 108 includes a connector 114 (e.g., a cable) that is configured to communicatively couple the transducer element 112 with a system (e.g., a marine vessel display system (e.g., system 200), a mobile device (e.g., notebook computer, smartphone, tablet, portable navigation system, or the like), a vehicle control system, a vehicle display system, a vehicle information/infotainment system, a vehicle navigation system, or the like). In other embodiments, the transducer assembly 108 may be wirelessly coupled to a system (e.g., via a transmitter or transceiver).

FIGS. 2A through 2D show various views of the transducer mounting device 102 in accordance with example embodiments of the present disclosure. The transducer mounting device 102 includes a deformable substrate 130 (e.g., a foam pad, flexible or deformable polymer, cork, plastic composition, rubber, a combination of the foregoing materials, and/or any other flexible or deformable material). For instance, the deformable substrate 130 may be formed of an ethylene-vinyl acetate (EVA) foam that is not water soluble and is solid (is stable and maintains its form) below 100 degrees (Celsius). The deformable substrate 130 has a first side 120 (e.g., an upper surface) and a second side 122 (e.g., a lower surface) that is opposite the first side 120. The deformable substrate 130 defines an aperture 124. For example, the deformable substrate 130 may be annular with an annular inner wall 128 that defines a periphery of the aperture 124. Although an annular substrate 130 is shown in FIGS. 2A through 2D, the deformable substrate 130 can have any shape. For example, the deformable substrate 130 can be square, rectangular, circular, elliptical, triangular, pentagonal, hexagonal, etc. In any such embodiment, the deformable substrate 130 includes one or more inner walls 128 that define the periphery of the aperture 124 defined by the deformable substrate 130. The aperture 124 may present any size, shape or configuration. For example, the aperture 124 may be configured to accommodate any sized transducer. The one or more inner walls 128 can also be configured in virtually any shape, for example, a square frame, rectangular frame, circular frame, elliptical frame, triangular frame, pentagonal frame, hexagonal frame, etc.

The aperture 124 is configured to receive the transducer assembly 108 so that at least a portion of the transducer assembly 108 is disposed between the first side 120 and the second side 122 (e.g., as shown in FIG. 1B). In this regard, the transducer mounting device 102 is configured to at least partially stabilize the transducer assembly 108 by retaining at least a portion of the transducer assembly 108 within the aperture 124. In embodiments, the transducer mounting device 102 includes at least one protrusion 126 that extends from the inner wall 128 of the deformable substrate 130 into the aperture 124 (e.g., towards a center of the aperture). For example, in an embodiment shown in FIGS. 2A through 2D, the transducer mounting device 102 includes a plurality of (e.g., three) protrusions 126 that extends from the inner wall (or walls) 128 of the deformable substrate 130 into the aperture 124 (e.g., towards a center of the aperture). The deformable substrate 130 can define any number of protrusions 126, for example, one, two, three, or more protrusions 126. In embodiments, the one or more protrusions 126 are configured to contact and at least partially stabilize (e.g., hold or support) the transducer assembly 108 within the aperture 124 (e.g., as shown in FIG. 1A). In some embodiments, the one or more protrusions 126 are configured to at least partially deform in order to tightly fit around at least a portion of the transducer assembly 108 so that the transducer assembly 108 is stabilized within the aperture 124. In this regard, the one or more protrusions 126 effectively reduce the distance (or separation) between the transducer assembly 108 (e.g., an outer wall of the transducer housing 110) and the inner wall (or walls) 128 of the transducer mounting device 102. In some embodiments, the transducer mounting device 102 includes a plurality of protrusions 126 that are located equidistantly (e.g., spaced equally apart) along the inner wall (or walls) 128 of the transducer mounting device 126. For example, the protrusions 126 can be evenly distributed about the periphery of the aperture 124. In some embodiment, the one or more protrusions 126 have an arc or point at an end of each protrusion (i.e., the end that is configured to contact the transducer assembly 108). In other embodiments, the end of each of the one or more protrusions 126 is flat or substantially flat.

The transducer assembly 108 may be mounted directly to an inner surface of the hull. In some embodiments, for an inner surface that is flat, the transducer assembly 108 may be installed in any hull area having a radius larger than 60 mm (diameter of 120 mm). For an inner surface that is concave, the transducer assembly 108 may be installed in any hull area having a radius larger than 100 mm (diameter of 200 mm). In some embodiments, the deformable substrate 130 has a thickness in the range of 10 to 20 mm. For example, in an embodiment, the deformable substrate 130 may be approximately 13 mm thick. In some embodiments, the deformable substrate 130 has an outer diameter or length of in the range of 60 to 100 mm (measured from the outer surfaces). For example, in an embodiment, the deformable substrate 130 may have an outer diameter of approximately 77 mm when measuring between the outer-most surfaces.

In some embodiments, the aperture 124 defined by the deformable substrate 130 has an inner radius or diameter (associated with inner-most surfaces, such as a distance from a center point of aperture 124 to each protrusion 126) and an outer radius or diameter (associated with portions of inner wall 128 other than the inner-most surfaces (protrusions 126), such as a distance from a center point of aperture 124 to inner wall 128. In embodiments, both the inner radius and the outer radius may be in the range of 30 to 55 mm. For example, in an embodiment, the aperture 124 has an inner diameter or width of approximately 44 mm measured between opposite points along a perimeter 136 associated with inner-most surfaces, such as protrusions 126, of the deformable substrate 130 (corresponding to a radius of 22 mm measured from a center point of aperture 124 to each protrusion 126). The aperture 124 may have an outer diameter of approximately 50 mm measured between opposite points along a perimeter associated with portions of inner wall 128 other than the inner-most surfaces (protrusions 126) (corresponding to a radium of 25 mm measured from a center point of aperture 124 to inner wall 128). The foregoing dimensions are provided as examples; however, it is contemplated that the transducer mounting device 102 can have any set of dimensions, which may be based upon given dimensions of a transducer assembly 108. In some implementations, the system 100 includes a set of transducer mounting devices 102 having a plurality of respective dimensions, where the transducer mounting device 102 for mounting the transducer assembly 108 is selected from the set of transducer mounting devices 102.

In embodiments, the transducer mounting device 102 includes an adhesive layer 132 for adhering the transducer mounting device 102 to the surface 106. For example, as shown in FIGS. 2C and 2D, the adhesive layer 132 may be disposed upon the second side 122 (e.g., the lower surface) of the deformable substrate 130. The adhesive layer 132 can include, but is not limited to, a glue, double sided tape, or the like. In some embodiments, the adhesive layer 132 is a waterproof, water resistant, and/or water tight adhesive layer. For example, the adhesive layer 132 can be water-proof and configured to prevent the flow of fluid (e.g., liquid and/or gas) substances between the surface 106 and the transducer mounting device 102, or between the surface 106 any components or materials bounded by the transducer mounting device 102 (e.g., the epoxy 104 and/or at least a portion of the transducer assembly 108). In an embodiment, the transducer mounting device 102 may further include a removable cover layer 134 disposed upon the adhesive layer 132. For example, the cover layer 134 may be removed from the second side 122 of the deformable substrate 130 to expose the adhesive layer 132. In some embodiments, the cover layer 134 comprises a treated paper or plastic layer (e.g., a wax paper layer), or the like.

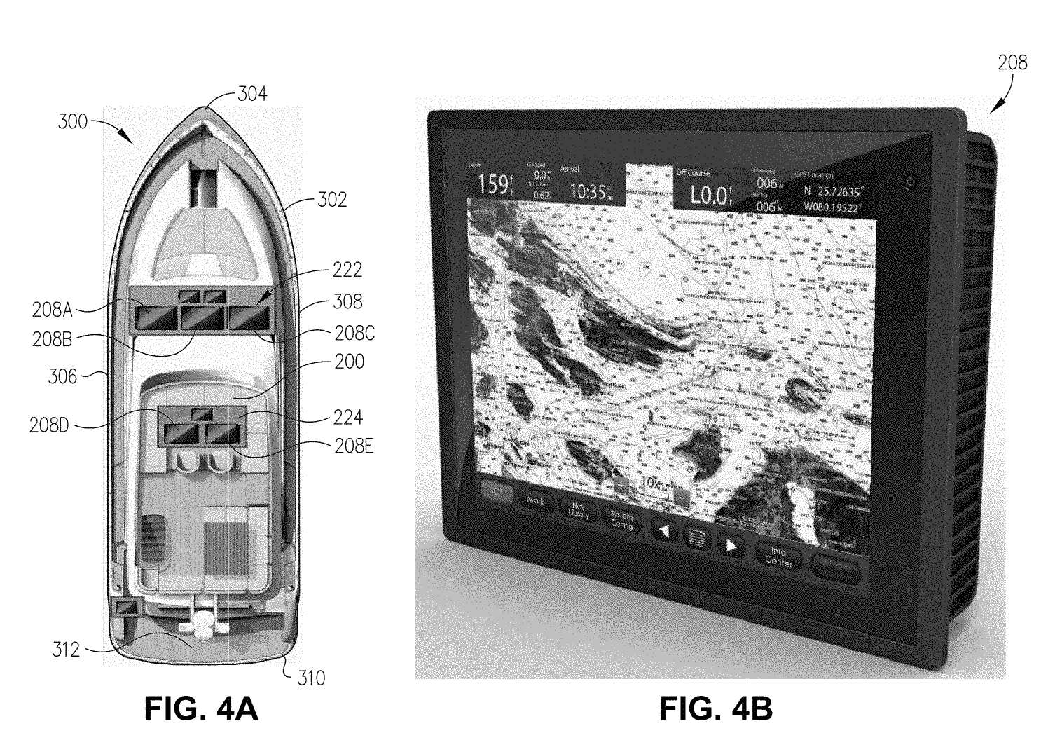

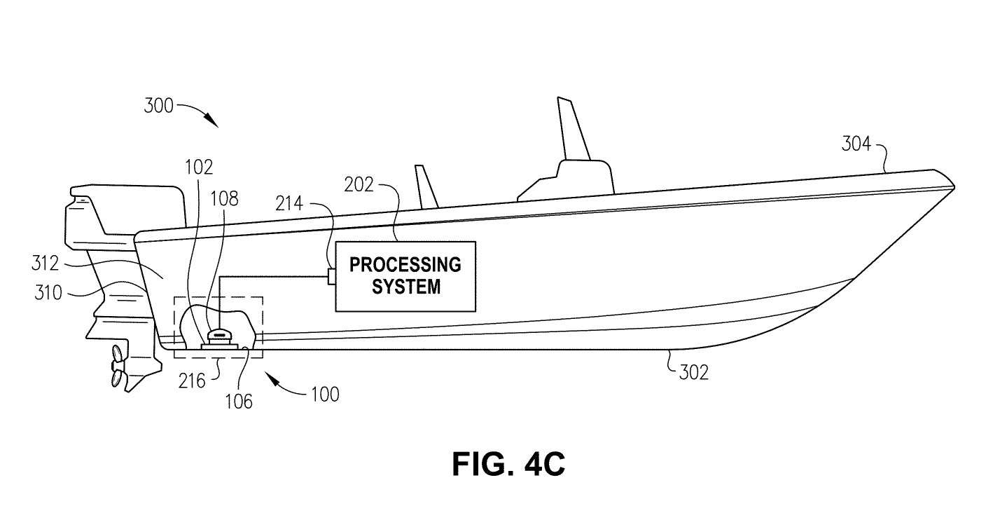

The transducer mounting device 102 can be used to aid in mounting the transducer assembly 108 to any surface. For example, in implementations, the transducer assembly 108 can be mounted to an inner surface of a vessel (e.g., a marine vessel, aircraft, car, truck, train, or the like). That is, the surface 106 can be a surface of a structure (e.g., a platform, wall structure, etc.) within the vessel and/or an inner surface of a portion of the vessel (e.g., a portion of the vessel's frame or body). For example, FIGS. 4A and 4C illustrate example implementations of the system 100 used to mount the transducer assembly 108 within a marine vessel 300 (e.g., a boat), where the mounting surface 106 is an inner surface of a hull 302 of the marine vessel 300. In some embodiments, the hull 302 is a fiberglass hull (e.g., a single thickness fiberglass hull). The transducer assembly 108 may be located anywhere within the marine vessel 300 (e.g., in proximity to the bow 304, port 306, starboard 308, or stern 310). The transducer assembly 108 may be mounted directly to an inner surface of the hull 302 to avoid challenges that may be encountered if the transducer assembly 108 is mounted aft of the water pickup (and other protrusions), over a strake, or over solid fiberglass (with no dead air space or coring in the boat hull 302). For example, the transducer assembly 108 may be mounted to an inner surface of the hull 302, in the bilge area near the keel and transom 312 of the marine vessel 300. The transducer assembly 108 may be mounted so that an emitting end 113 of the transducer element 112 is disposed against the hull 302 (e.g., against surface 106, where surface 106 is an inner surface of the hull 302). In some implementations, the transducer assembly 108 is mounted to an inner surface of the hull 302 that has a deadrise angle less than or equal to 6 degrees because installing the transducer assembly 108 at a location with a deadrise angle in excess of 6 degrees may increase the difficulty of mounting the transducer assembly 108 with the transducer mounting device 102 described herein. The “deadrise angle” can be the angle between a horizontal line and the boat hull 302 at a single point. The sonar beam output by the transducer element 112 may be output at an angle corresponding to the deadrise angle. In some implementations, the transducer assembly 108 is mounted to a mounting location on the surface 106 (e.g., an inner surface of the hull 302) that is flat or substantially flat (e.g., at a location with a deadrise angle of zero or near zero) in order to collect information regarding the environment or structures directly below the marine vessel 300.

As shown in FIG. 1B, the transducer assembly 108 may be positioned at a mounting location (e.g., on surface 106) of the hull 302 of the marine vessel 300. The transducer assembly 108 can be at least partially submerged within the epoxy 104 that is retained by the transducer mounting device 102 (e.g., within the aperture 124). In some embodiments, the epoxy 104 can include a quick-curing epoxy. The epoxy 104 can include, but is not limited to, an epoxy resin, putty, glue, sealer, hardener, rubber cement, or the like. The epoxy 104 may be disposed within the aperture 124 prior to disposing the transducer assembly 108 within the aperture. In some embodiments, the epoxy is a marine epoxy or a marine-grade epoxy. The epoxy 104, when cured (e.g., by exposure to the atmosphere (e.g., drying), heating, cooling, light curing, or the like), is configured to affix the transducer assembly 108 to the surface 106 (e.g., an inner surface of the hull 302). In embodiments, the transducer element 112 of the transducer assembly 108 is firmly pressed against the surface 106 (e.g., while the epoxy 104 is cured) to avoid air bubbles and/or excessive or uneven epoxy 104 between the emitting end 113 of the transducer element 112 and the mounting location on the surface 106. This can help to improve performance (e.g., signal strength, signal-to-noise ratio (SNR), etc.) for the transducer element 112. In embodiments, the epoxy 104 fills (or substantially fills) a volume within the aperture 124 other than the volume occupies by the transducer assembly 108. This can also improve performance of transducer element 112. In embodiments, the thickness of the deformable substrate 130 and/or the fill height of the epoxy 104 exceeds a thickness of the transducer element 112 within the transducer housing 110.

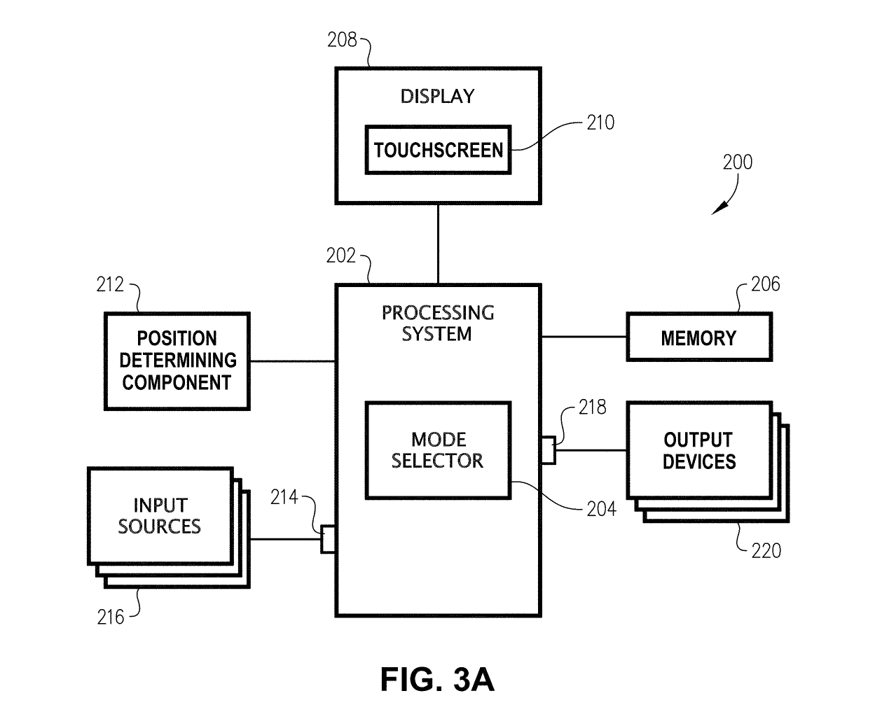

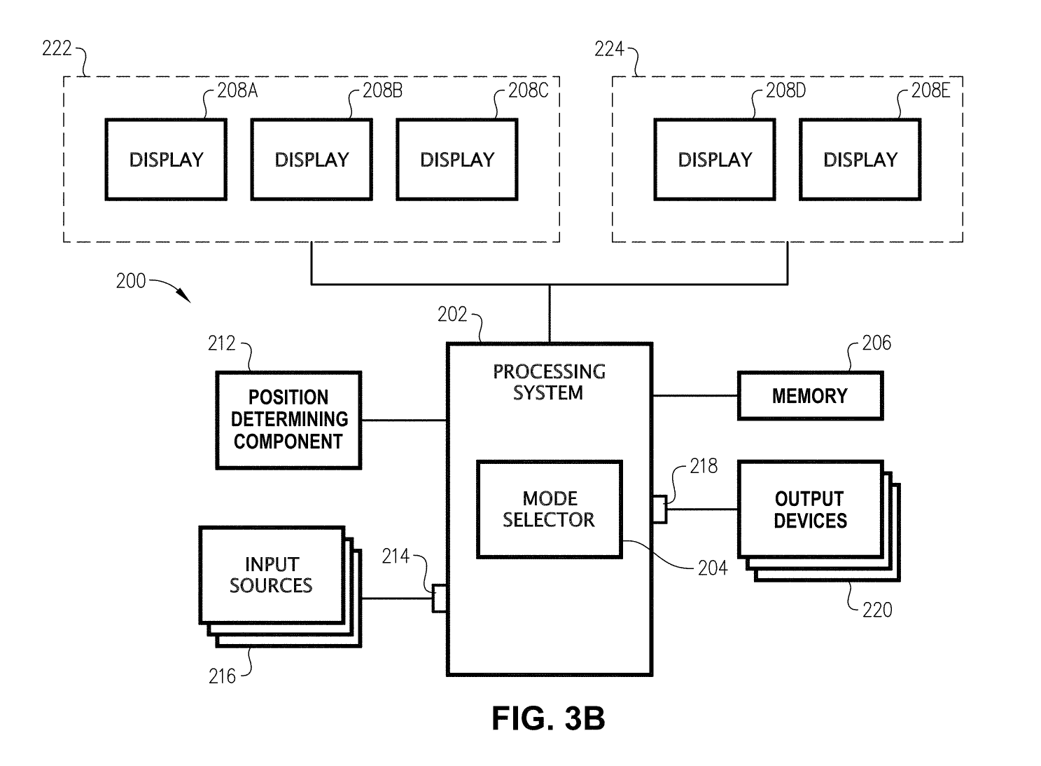

FIGS. 3A through 4C illustrate a marine vessel display system 200 that can include or can be communicatively coupled with a transducer assembly, such the transducer assembly 108 described herein, in accordance with example embodiments of the present disclosure. The marine vessel display system 200 may be mounted in a marine vessel 300 such as a boat, ship, sailboat, or other watercraft, as shown in FIG. 4A. The marine vessel display system 200 may assist operators of the marine vessel 300 in monitoring information related to the operation of the marine vessel 300. As utilized herein, the term operator may mean any user of the marine vessel display system 200. For example, an operator may be an owner of the marine vessel 300, a crew member, a pilot, a passenger, and so forth.

As shown in FIGS. 3A and 3B, the marine vessel display system 200 can include at least one input 214 for receiving data from one or more marine input sources 216; a display 208 for presenting information representative of at least some of the data from the marine input sources 216; and a processing system 202 in communication with the inputs 214 and the display 208. As described in more detail below, the processing system 202 may implement a plurality of modes of operation, each of which may cause the display 208 to present information representative of data from predetermined ones of the marine input sources 216 and in selected formats. The marine vessel display system 200 may further comprise a position-determining component 212 that furnishes geographic position data for the marine vessel 300. The processing system 202 may implement a mode selector 204 configured to select between a plurality of modes of operation, respective ones of which present information representative of data from selected marine input sources 216 on the display 208. The processing system may further be configured to cause at least one of automatic activation or deactivation of an equipment of the marine vessel (e.g., turn on a fish finder, start a trolling motor, activate an anchor system, start or shut down the engines of the marine vessel, activate a navigation system, etc.) during selection of a particular mode of operation.

The input 214 may be any wireless or wired device or devices for receiving data from the marine input sources 216 and transferring the data to the processing system 202. The input 214 may comprise, for example, one or more Ethernet ports, Universal Serial Bus (USB) Ports, High Definition Multi-Media Interface (HDMI) ports, memory card slots, video ports, radio frequency (RF) receivers, infrared (IR) receivers, Wi-Fi receivers, Bluetooth devices, and so forth.

The marine input sources 216 may provide data to the processing system 202 and may comprise any measurement devices, sensors, receivers, or other components that sense, measure, or otherwise monitor components of the marine vessel 300 or its surroundings. For example, the marine input sources 216 may include sensors that measure or sense vessel fuel level, wind speed, wind direction, vessel temperature, ambient temperature, water current speed, rudder position, an azimuth thruster position, water depth, boat water storage level, anchor status, boat speed, combinations thereof, and the like. In an embodiment (e.g., as shown in FIG. 4C), a marine input source 216 includes an integrated or external sonar sounder (e.g., transducer assembly 108) including a sonar transducer (e.g., transducer element 112). In some embodiments, the marine input sources 216 can also include an integrated or external radar scanner or other proximity sensor.

The marine input sources 216 may also include transmitters, receivers, transceivers, and other devices that receive data from external sources. For example, the marine input sources 216 may include an integrated or external weather receiver for receiving weather data from a weather source, a satellite entertainment system receiver for receiving entertainment content broadcast via satellite, and/or a global positioning system (GPS) receiver or other satellite navigation receiver for receiving navigation signals.

The marine input sources 216 may also comprise a receiver or other device for communicating with transmitters or other devices worn by crew and/or passengers (hereinafter “wearable transmitter”) on the marine vessel 300. For example, crew and passengers of the marine vessel 300 may be provided with a wearable transmitter configured to warn of “man overboard” emergencies. Such a wearable transmitter may detect when the wearer is no longer on the marine vessel 300, for example, by sensing the presence of water or by comparing the current geographic position of the wearer to the current geographic position of the marine vessel 300, and may thereafter provide a transmission to cause the marine vessel display system 200 to enter a man overboard mode of operation and to aid in the recovery of the wearer (e.g., by providing the GPS position of the wearer, a locating beacon, or the like). Similarly, crew and passengers of the marine vessel 300 may be provided with a wearable transmitter that is configured to provide a transmission when the wearable transmitter, or an associated medical monitoring device, detects that the wearer is experiencing a medical emergency or health issue. The transmission may cause the marine vessel display system 200 to initiate an automated communication requesting assistance (e.g., an S.O.S. radio transmission), initiate an autopilot mode of operation, or the like. Still further, crew and passengers of the marine vessel 300 may be provided with a wearable transmitter that is configured to provide radio communication between the wearer and an operator of the marine vessel display system 200. In embodiments, a wearable transmitter may be provided that is capable of furnishing multiple functions such as those described herein above.

The marine input sources 216 may also comprise a security system for monitoring, ports, doors, windows, and other parts of the marine vessel 300 against unauthorized access and one or more cameras for providing video and/or other images of the marine vessel 300 and/or surroundings of the marine vessel 300.

The marine input sources 216 may comprise one or more computers and/or handheld electronic devices that may be used to transfer data to the marine vessel display system 200. The marine input sources 216 may be integrally formed with the marine vessel display system 200, may be stand-alone devices, or may be a combination of both. For example, a sonar sounder may be integrated into the marine vessel display system 200 or may be an external sonar sounder module. Similarly, a radar scanner may be integrated into the marine vessel display system 200 or be an external device. The marine input sources 216 may be operated and/or adjusted using controls on the marine vessel display system 200 or may have their own controls.

The display 208 may be communicatively coupled with the processing system 202 and may be configured for displaying text, data, graphics, images and other information representative of data from the marine input sources 216 and/or other sources. An example embodiment of the display 208 is shown in FIG. 4B. The display 208 may be a liquid crystal display (LCD), light-emitting diode (LED) display, light-emitting polymer (LEP) display, thin film transistor (TFT) display, gas plasma display, or any other type of display. The display 208 may be backlit such that it may be viewed in the dark or other low-light environments. The display 208 may be of any size and/or aspect ratio, and in one or more embodiments, may be 15 inches, 17 inches, 19 inches, or 24 inches (measured diagonally). In some embodiments, the display 208 may include a touchscreen display 210. The touchscreen display 210 may employ any touchscreen technology, including, but not limited to, resistive, capacitive, or infrared touchscreen technologies, or any combination thereof.

The processing system 202 may control the presentation of information on the display 208, may perform other functions described herein, and can be implemented in hardware, software, firmware, or a combination thereof. The processing system 202 may include any number of processors, controllers, microprocessors, microcontrollers, programmable logic controllers (PLCs), field-programmable gate arrays (FPGAs), application specific integrated circuits (ASICs), or any other component or components that are operable to perform, or assist in the performance of, the operations described herein.

The processing system 202 may also be communicatively coupled to or include memory 206 for storing instructions or data. The memory 206 may be a single component or may be a combination of components that provide the requisite storage functionality. The memory 206 may include various types of volatile or non-volatile memory such as flash memory, optical discs, magnetic storage devices, SRAM, DRAM, or other memory devices capable of storing data and instructions. The memory 206 may communicate directly with the processing system 202, or may communicate over a data bus or other mechanism that facilitates direct or indirect communication. The memory 206 may optionally be structured with a file system to provide organized access to data existing thereon.

The memory 206 may store one or more databases that may include information about the marine vessel 300 in which the marine vessel display system 200 is used, such as the length, width, weight, turning radius, top speed, draft, minimum depth clearance, minimum height clearance, water capacity, fuel capacity and/or fuel consumption rate of the marine vessel 300. The databases may also store information related to the locations and types of navigational aids including buoys, markers, lights, or the like. In some embodiments, the information related to navigational aids may be provided by the Coast Guard or other map data sources.

The processing system 202 may implement one or more computer programs that provide the modes of operation described below, that control the display of information on the display 208 as described herein, and/or that cause automatic activation or deactivation of an equipment of the marine vessel during selection of the first mode of operation. The computer programs may comprise ordered listings of executable instructions for implementing logical functions in the processing system 202. The computer programs can be embodied in any non-transitory computer-readable medium for use by or in connection with an instruction execution system, apparatus, or device, such as a computer-based system, processor-containing system, or other system that can fetch the instructions from the instruction execution system, apparatus, or device, and execute the instructions. In the context of this application, a “computer-readable medium” can be any non-transitory means that can contain, store, communicate, propagate or transport the program for use by or in connection with the processing system 202 or other instruction execution system, apparatus, or device. The computer-readable medium can be, for example, but not limited to, an electronic, magnetic, optical, electro-magnetic, infrared, or semi-conductor system, apparatus, device, or propagation medium. More specifically, although not inclusive, examples of the computer-readable medium would include the following: an electrical connection having one or more wires, a portable computer diskette, a random access memory (RAM), a read-only memory (ROM), an erasable, programmable, read-only memory (EPROM or Flash memory), an optical fiber, and a portable compact disk read-only memory (CDROM).

In accordance with the present disclosure, the processing system 202 may implement a plurality of modes of operation, each of which may present information representative of data from selected marine input sources 216 via the display 208. In some embodiments, the information may be presented in a desired format to minimize confusion and increase ease of use. For example, the processing system 202 may implement a pre-trip planning mode in which information representative of trip planning data is presented on the display 208. The trip planning data may be uploaded, transmitted, or otherwise communicated to the marine vessel display system 200 from one or more marine input sources 216 and may include route planning data; waypoint data; journey plans; forecasted wind, current, storm, and/or tidal conditions; vessel fuel requirements; vessel water requirements; and other data that may be useful to an operator while planning a journey. The pre-trip planning mode may permit an operator to create a journey plan or similar plan on a remote or local computer and then transfer information related to the plan to the marine vessel display system 200 so it can be presented on the display 208 and accessed by the operator while operating the marine vessel 300.

The processing system 202 may also implement a boat preparation mode in which information representative of water storage data, fuel level data, hatch status data and/or other boat readiness data is presented on the display 208. The boat preparation mode may provide information related to a boat's readiness for use.

The processing system 202 may also implement a close quarters mode in which information representative of proximity data and navigation data is presented on the display 208. The close quarters mode may be particularly useful when navigating in a harbor or other confined area when an operator needs to be aware of his or her vessel's location relative to other vessels and obstacles. The close quarters mode may also present information from a pilot book, local speed limits, rules, regulations, and so forth, on the display 208.

The processing system 202 may also implement a docking/undocking mode in which information representative of proximity data from a proximity sensor, wind data from a wind sensor, water current data from a current sensor, rudder position data from a rudder position sensor, and/or azimuth thruster position data from an azimuth thruster position sensor is presented on the display 208. The docking/undocking mode permits an operator to view representations of obstacles such as stationary boats, docks, and other hazards while simultaneously monitoring wind conditions, current conditions, and the status of components on the vessel while docking or undocking the vessel.

The processing system 202 may also implement a main transit mode in which information representative of fuel level data, navigation data, water depth data, and/or weather data is presented on the display 208. A feature of the main transit mode may be monitoring the progress of the marine vessel 300 against a journey plan. For example, the processing system 202 may compare information related to a desired path of transit with the current position of the marine vessel 300 received from the position-determining component 212 while the marine vessel 300 is in transit to determine if the marine vessel 300 is off course, has enough fuel to reach its intended destination, and so forth, and may then display such information on the display 208. The main transit mode may also present information representative of nearby vessels, obstacles, and so forth.

The processing system 202 may also implement an anchoring mode in which information representative of the anchor status data, wind data, depth data, tide data, proximity data, and/or navigation is presented on the display 208. The anchoring mode may permit an operator to find suitable locations to anchor the marine vessel 300, and alert the operator if the anchor is dragging and/or if the marine vessel 300 is moving when it should not be.

The processing system 202 may also implement an off-boat monitoring mode in which information representative of security data, anchor status data, wind data, and/or weather data is presented on the display 208. In some embodiments, the marine vessel display system 200 may send texts, images, and so forth, to a remote device, such as an operator's mobile telephone or a computer, via a cellular telephone connection, radio frequency transmitter, the Internet, and so forth, so that the operator may monitor the marine vessel 300 remotely.

The processing system 202 may also implement a fishing mode in which information representative of fish finder data, water temperature data, navigation data, and/or proximity data is presented on the display 208. The fishing mode may allow an operator to view representations of fish, other boats, and hazards while fishing and to monitor water conditions to determine if they are conducive to fishing.

The processing system 202 may also implement a boat storage and transport mode in which information representative of photographic data, navigation data, and/or proximity data is presented on the display 208. As with the off-boat monitoring mode, the processing system 202 may display such information on the display 208 and/or transmit it to a remote device.

The processing system 202 may also implement a man overboard mode in which information representative of passenger location data and/or navigation data is presented on the display 208. The man overboard mode may display an alert and/or sound an alarm when any of the location devices worn by passengers indicate that a passenger is outside of a threshold distance from the marine vessel 300 and may have fallen overboard. The man overboard mode may also record and display the last known coordinates for the passenger when he or she left the marine vessel 300 and may automatically send such data to a marine rescue authority such as the United States Coast Guard or the like.

The processing system 202 may also implement a hazard hit mode in which information representative of bilge water level data is presented on the display 208. The hazard hit mode may allow an operator to quickly determine if the marine vessel 300 is taking on water and, if so, the rate at which the marine vessel 300 is taking on water. The hazard hit mode may also determine if a bilge pump can remove the water quickly enough to keep the marine vessel 300 afloat or if the marine vessel 300 should be abandoned. The hazard hit mode may also alert authorities such as the United States Coast Guard, or the like, of the position and status of the marine vessel 300.

The above-described modes of operation are only examples of modes that may be implemented by the processing system 202. Other modes of operation, or combinations or portions of the above-described modes, may also be implemented without departing from the scope of the invention.

In addition to displaying information from one or more selected marine input sources 216, each mode of operation may present information in a particular operator-selected or otherwise predetermined format. For example, some of the information may be presented in the form of one or more virtual devices that mimic the appearance and/or function of a gauge, instrument, or other analog device. Each virtual device may have a unique collection of graphical and functional properties that may be configured by a layout designer and/or adjusted by an operator. Examples of virtual devices that may be presented with the marine vessel display system 200 include a chartplotter, a radar screen, a fishfinder, a camera/video screen, digital instruments with numbers, analog instrument gauges, autopilot interfaces, and entertainment interfaces. In some embodiments, the display format may change based on a current operating mode. For example, if the selected mode of operation from a first mode of operation, such as a main transit mode of operation, to a second mode of operation, such as a docking/undocking, anchoring, or fishing mode of operation or other modes of operation, the display format may change accordingly to accommodate features relevant to the selected mode of operation.

The processing system 202 may further be configured to cause automatic activation or deactivation of various equipment of the marine vessel during selection of particular modes of operation. In embodiments, equipment of the marine vessel 300 for which use may be expected or possible during the time a mode of operation is selected may be associated with that mode of operation. The processing system 202 may then automatically activate such equipment when the mode of operation is selected. Similarly, the processing system 202 may automatically deactivate other equipment that is no longer expected to be used while the mode of operation is selected. For example, when a fishing mode is selected the processing system 202, the processing system 202 may issue a command to shut down or idle the marine vessel's engine, start a trolling motor, and/or turn on a fish finder. Similarly, when a hazard hit mode is initiated, the processing system 202 may automatically cause a bilge pump to be turned on, and/or may automatically tune a marine radio to alert authorities such as the United States Coast Guard, or the like, of the position and status of the marine vessel 300 (e.g., transmit an S.O.S. call). In embodiments, the processing system 202 may be configured to cause the automatic activation or deactivation of one or more output devices 220 via an output 218 when a particular mode of operation is selected, as described below.

The position-determining component 212 may be configured to provide location-determining functionality for the marine vessel display system 200 and, optionally, the marine input sources 216 and/or other system and components employed by the marine vessel 300. Location-determining functionality, for purposes of the following discussion, may relate to a variety of different navigation techniques and other techniques that may be supported by “knowing” one or more locations. For instance, location-determining functionality may be employed to provide location data, timing data, speed data, and/or a variety of other navigation-related data.

In implementations, the position-determining component 212 may comprise a receiver that is configured to receive signals from one or more position-transmitting sources. For example, the position-determining component 212 may be configured for use with a Global Navigation Satellite system (GNSS). In embodiments, the position-determining component 212 may be a global positioning system (GPS) receiver operable to receive navigational signals from GPS satellites and to calculate a location of the marine vessel 300 as a function of the signals.

While a GPS system is described herein, it is contemplated that a wide variety of other positioning systems may also be used, such as terrestrial based systems (e.g., wireless-telephony systems or data systems that broadcast position data from cellular towers), wireless networks that transmit positioning signals, and so on. For example, positioning-determining functionality may be implemented through the use of a server in a server-based architecture, from a ground-based infrastructure, through one or more sensors (e.g., gyros or odometers), and so on. Other example systems include, but are not limited to, a Global Orbiting Navigation Satellite System (GLONASS), a Galileo navigation system, or other satellite navigation system.

The output 218 may be any wired or wireless port, transceiver, memory slot, or other device for transferring data or other information from the processing system 202 to the output devices 220. The output devices 220 may be any devices capable of receiving information from the processing system 202 or being controlled by the marine vessel display system 200 such as a marine radio, beacon, lighting system, and so forth. In embodiments, the processing system 202 may be configured to cause at least one of automatic activation or deactivation of the output devices 220 via the output 218. For example, the processing system 202 may automatically tune a channel on a marine radio, activate or deactivate a beacon, turn a lighting system on or off, or the like, during selection of various modes of operation.

The marine vessel display system 200 may also include a speaker for providing audible instructions and feedback, a microphone for receiving voice commands, an infrared port for wirelessly receiving and transmitting data and other information from and to nearby electronics, and other information, and a cellular or other radio transceiver for wirelessly receiving and transmitting data from and to remote devices.

In addition to the input 214 and output 218, the marine vessel display system 200 may also include a number of other Input/Output (I/O) ports that permit data and other information to be communicated to and from the processing system 202. The I/O ports may include one or more removable memory card slots, such as a micro SD card slot, or the like for receiving removable memory cards, such as microSD cards, or the like, and/or an Ethernet port for coupling a processing system 202 to another processing system such as a personal computer. Databases of geographic areas cross-referenced with modes of operation, navigational software, cartographic maps and other data and information may be loaded in the marine vessel display system 200 via the I/O ports, the wireless transceivers, or the infrared port mentioned above. The data may be stored in memory 206 of processing system 202. In some embodiments, stored cartographic maps may be upgraded, downgraded, or otherwise modified in the background without interfering with the primary uses of the marine vessel display system 200. If multiple processing systems 202 are employed by the marine vessel display system 200, the upgrade, downgrade, or modification may be applied to all processing systems 202. Thus, for example, the various components of the marine vessel display system 200 may be easily upgraded, downgraded, or modified without manually and tediously installing the same data on each of the components. Such functionality may also facilitate data uniformity among the various components of the marine vessel display system 200.

The marine vessel display system 200 may further include at least one housing that encloses and protects the other components of the marine vessel display system 200 from the environment (e.g., moisture, contaminants, vibration, impact, etc.). The housing may include mounting hardware for removably securing the marine vessel display system 200 to a surface within the marine vessel 102 or may be configured to be panel-mounted within the marine vessel 102. The housing may be constructed from a suitable lightweight and impact-resistant material such as, for example, plastic, nylon, aluminums, composites, steels, or any combination thereof. The housing may include appropriate gaskets or seals to make it substantially waterproof or water resistant. The housing may take any suitable shape or size, and the particular size, weight and configuration of the housing may be changed without departing from the scope of the present disclosure.

FIG. 3B illustrates an embodiment of the marine vessel display system 200, where the marine vessel display system 200 employs a plurality of independent displays (e.g., displays 208A through 208E). Two or more of the displays (e.g., displays 208A through 208E) may be mounted proximate (e.g., adjacent) to one another to form one or more display stations in the marine vessel 300. For example, as illustrated in FIGS. 3B and 4A, three displays 208A, 208B, 208C may be mounted together to form a first display station 222 in a first area of the marine vessel 300, and two other displays 208D, 208E may be mounted together to form a second display station 224 in a second area of the marine vessel 300. The marine vessel display system 200 may also include additional displays 108 grouped into one or more additional display stations. The embodiments described herein and shown in the figures are example implementations of the technology; however, it is contemplated that any number of displays and/or display stations can be employed by the marine vessel display system 200 without departing from the scope of this disclosure. Furthermore, the processing system 202 may be any configuration of processors that enables communication with one or more displays (e.g., displays 208A through 208E). In some embodiments, each display 208 and/or display station 222 or 224 may have a separate processing system 202, or one processing system 202 may control all displays 208 of both display stations 222 and 224 and any other display stations, or any combination thereof (e.g., some displays 208 have respective separate processing systems 202 and some displays 208 have shared processing systems 202). In embodiments including multiple processing systems 202 for respective displays 208 and/or display stations 222 or 224, the processing systems 202 may coordinate their activities with other processing systems 202 of the marine vessel display system 200. The processing system 202 may include any number of processors, micro-controllers, or other processing systems and resident or external memory for storing data and other information accessed or generated by the marine vessel display system 200.

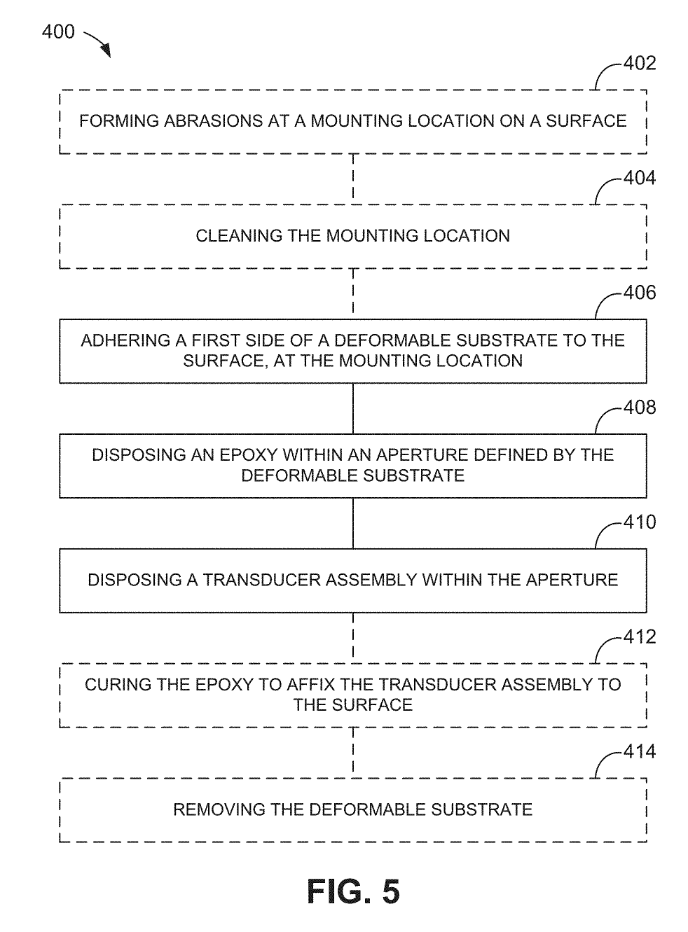

FIG. 5 illustrates an example process 400 that employs a transducer mounting device 102 (or system 100) to mount a transducer assembly 108 to a surface 106 (e.g., a surface within and/or an inner surface of a vessel (e.g., marine vessel 300)). FIGS. 6A through 6F illustrate an installation of a transducer assembly 108 (e.g., mounting of the transducer assembly 108 to surface 106), in accordance with an example implementation of the present disclosure. In general, operations of disclosed processes (e.g., process 200) may be performed in an arbitrary order, unless otherwise provided in the claims.

In an implementation, a mounting location on a surface may be prepared by forming abrasions at the mounting location (block 402) and/or cleaning the mounting location (block 404). For example, as shown in FIG. 6A, abrasions 142 are formed at a mounting location 140 on the surface 106 (e.g., inner surface of a hull 302 of a marine vessel 300). In some implementations, the abrasions 142 are formed by sanding the mounting location 140 with an abrasive material (e.g., sand paper, steel wool, or the like). For example, the abrasions 142 may be formed at the mounting location 140 with sandpaper (e.g., 80-grit sandpaper). The mounting location 140 may be cleaned using rubbing alcohol or any appropriate cleansing solution to remove dirt and debris that can cause unwanted bubbles underneath the transducer assembly 108 when it is mounted to the surface 106. The abrasions 142 can improve wettability of the mounting location 140 to improve adhesion between the epoxy 104 and the surface 106 at the mounting location 140. In some implementations, the process 400 further includes forming abrasions at and/or cleaning the emitting end 113 of the transducer assembly 108 in order to improve its wettability (e.g., to improve adhesion between the epoxy 104 and the emitting end 113 of the transducer assembly 108).

A deformable substrate is adhered to a surface (e.g., at a mounting location on the surface) (block 406). For example, as shown in FIG. 6C, the deformable substrate 130 can be pressed onto the surface 106 with the adhesive layer 132 on the second side 122 (e.g., lower surface) of the deformable substrate 130 facing the surface 106. In some implementations (e.g., as shown in FIG. 6B), the cover layer 134 is removed from the second side 122 of the deformable substrate 130 to expose the adhesive layer 132 on the second side 122 of the deformable substrate 130 before the deformable substrate 130 is pressed onto the surface. In other implementations, the deformable substrate 130 can be adhered to the surface 106 with an adhesive (e.g., glue, double sided tape, epoxy, etc.) that is separate from the transducer mounting device 102 (i.e., an adhesive that does not form a portion of the device 102).

An epoxy is disposed within an aperture defined by the deformable substrate (block 408). For example, as shown in FIG. 6D, the epoxy 104 can be disposed (e.g., flowed or dispensed) into the aperture 124 defined by the deformable substrate 130 of the transducer mounting device 102. The epoxy 104 may be disposed within the aperture 124 to a fill level so that the volume within the aperture 124 is entirely or substantially entirely (e.g., at least 80%) filled when the transducer assembly 108 is disposed within the aperture 124 (i.e., after the transducer assembly 108 displaces a portion of the epoxy). The fill level of the epoxy 104 after the transducer assembly 108 has been disposed within the aperture 124 can be at least the height of the transducer element 112 of the transducer assembly 108. In some implementations, before the transducer assembly 108 is disposed within the aperture 124, the aperture 124 is only partially filled with epoxy 104 (e.g., to one fourth to one half (e.g., one third) of the height of its inner wall 128). The one or more inner walls 128 of the transducer mounting device 102 are configured to retain most, if not all, of the epoxy 104 within the bounds of the transducer mounting device 102. For example, the adhesive layer 132 can be configured to form a water resistant, waterproof, and/or water tight seal between the deformable substrate 130 and the surface 106.

A transducer assembly is disposed within the aperture so that at least a portion of the transducer assembly is disposed between a first side of the deformable substrate and a second side of the deformable substrate (block 410). For example, as shown in FIG. 6E, the transducer assembly 108 is pressed into the epoxy 104 within the aperture 124 so that at least a portion of the transducer assembly 108 is between the first side 120 of the deformable substrate 130 and the second side 122 of the deformable substrate 122. In some implementations, the transducer assembly 108 is rotated (e.g., 30 to 360 degrees, or more) while it is pressed into the epoxy 104 to securely positon the transducer assembly 108 in proximity to (e.g., in contact or near contact with) the surface 106. For example, the transducer assembly 108 may be rotated at least 90 degrees while it is pressed into the epoxy 104.

The epoxy 104 can be cured to affix the transducer assembly 108 to the surface 106 (block 412). In some implementations, the epoxy 104 is a quick-curing epoxy that cures after a period of time (e.g., drying time). For example, in an implementation, the epoxy 104 may securely affix the transducer assembly 108 to the surface 106 after 1 to 10 minutes (e.g., 5 minutes). In another implementation, the epoxy 104 can be cured by heating, cooling, light curing (e.g., UV or laser curing), or the like. In implementations, the transducer assembly 108 is stabilized (e.g., held firmly in place and/or pressed onto the surface 106), for example, by hand or mechanically (e.g., using tape, rope, and/or any other fastener) for the period of time (i.e., until the curing process has been completed and the epoxy 104 hardens).

In some implementations, the transducer mounting device 102 is retained as part of the final structure (e.g., as shown in FIG. 6E). In other implementations, the process 400 further includes removing the deformable substrate 130 after curing the epoxy 104 (block 414). For example, as shown in FIG. 6F, the deformable substrate 130 can be removed to leave the epoxy 104 and the transducer assembly 108 affixed to the surface 106 by the epoxy 104. In some implementations, to improve removability of the transducer mounting device 102, the one or more inner walls 128 of the transducer mounting device 102 can be textured to have low wettability (e.g., the one or more inner walls 128 can be smooth). Additionally or alternatively, the one or more inner walls 128 of the transducer mounting device 102 may be treated with a coating (e.g., lubricant (e.g., oil), wax or wax paper like coating, or the like) that has low wettability.

Although the technology has been described with reference to the embodiments illustrated in the attached drawing figures, equivalents may be employed and substitutions made herein without departing from the scope of the technology as recited in the claims. For example, the components described herein need not be physically connected to one another since wireless communication among the various depicted components is permissible and intended to fall within the scope of the present invention. Components illustrated and described herein are merely examples of a device and components that may be used to implement the embodiments of the present invention and may be replaced with other devices and components without departing from the scope of the invention.

What is claimed is:

1. A device for mounting a transducer assembly within a vessel, the device comprising:
a deformable substrate having a first side and a second side, the deformable substrate defining an aperture configured to receive a transducer assembly so that at least a portion of the transducer assembly is disposed between the first side and the second side; and
an adhesive layer disposed upon the second side of the deformable substrate, the adhesive layer configured to adhere the deformable substrate to a surface within a vessel.

2. The device as recited in claim 1, further comprising:
a removable cover layer disposed upon the adhesive layer.

3. The device as recited in claim 1, wherein the deformable substrate further defines at least one protrusion extending from an inner wall of the deformable substrate into the aperture, the at least one protrusion configured to at least partially stabilize the transducer assembly within the aperture.

4. The device as recited in claim 1, wherein the deformable substrate further defines at least three protrusions extending from at least one inner wall of the deformable substrate into the aperture, the at least three protrusions configured to at least partially stabilize the transducer assembly within the aperture.

5. The device as recited in claim 4, wherein the at least three protrusions are disposed about a periphery of the aperture.

6. The device as recited in claim 1, wherein the aperture comprises an annular aperture.

7. The device as recited in claim 1, wherein the deformable substrate comprises a foam pad.

8. A system comprising:
a deformable substrate having a first side and a second side, the deformable substrate defining an aperture configured to receive a transducer assembly so that at least a portion of the transducer assembly is disposed between the first side and the second side;
an adhesive layer disposed upon the second side of the deformable substrate, the adhesive layer configured to adhere the deformable substrate to a surface within a vessel; and
an epoxy disposed within the aperture, the epoxy configured to affix the transducer assembly to the surface.

9. The system as recited in claim 8, wherein the deformable substrate further defines at least one protrusion extending from an inner wall of the deformable substrate into the aperture, the at least one protrusion configured to at least partially stabilize the transducer assembly within the aperture.

10. The system as recited in claim 8, wherein the deformable substrate further defines at least three protrusions extending from at least one inner wall of the deformable substrate into the aperture, the at least three protrusions configured to at least partially stabilize the transducer assembly within the aperture.

11. The system as recited in claim 10, wherein the at least three protrusions are disposed about a periphery of the aperture.

12. The system as recited in claim 8, wherein the aperture comprises an annular aperture.

13. The system as recited in claim 8, wherein the deformable substrate comprises a foam pad.

14. The system as recited in claim 8, wherein the epoxy comprises a marine-grade epoxy.

15. A method for mounting a transducer assembly within a vessel, the method comprising:
adhering a deformable substrate to a surface within a vessel;
disposing an epoxy within an aperture defined by the deformable substrate; and
disposing a transducer assembly within the aperture so that at least a portion of the transducer assembly is disposed between a first side of the deformable substrate and a second side of the deformable substrate.

16. The method as recited in claim 15, further comprising:
curing the epoxy to affix the transducer assembly to the inner surface of the vessel.

17. The method as recited in claim 16, further comprising:
removing the deformable substrate after curing the epoxy.

18. The method as recited in claim 15, wherein adhering the deformable substrate with the inner surface of the vessel comprises:
removing a cover layer disposed upon an adhesive layer on the second side of the deformable substrate; and
placing the second side of the deformable substrate in contact with the inner surface of the vessel.

19. The method as recited in claim 15, further comprising:
forming abrasions at a mounting location on the surface; and
cleaning the mounting location prior to adhering the deformable substrate to the surface, at the mounting location.

20. The method as recited in claim 19, wherein forming abrasions at the mounting location comprises:
sanding the mounting location with an abrasive material.
